(19) United States
(12) Patent Application Publication
(10) Pub. No.: US 2026/0125240 A1
(43) Pub. Date: May 7, 2026

(54) LINKAGE OPERATING DEVICE FOR ELEVATOR SYSTEM AND ELEVATOR SYSTEM

(71) Applicant: Otis Elevator Company, Farmington, CT (US)

(72) Inventors: Yingjie Li, Tianjin (CN); Yue Liu, Tianjin (CN); Hong Fu, Tianjin (CN)

(21) Appl. No.: 19/375,729

(22) Filed: Oct. 31, 2025

(30) Foreign Application Priority Data
Nov. 7, 2024 (CN) 202411585396.0

(51) Int. Cl. B66B 5/00; B66B 11/02

(52) U.S. Cl. CPC B66B 5/0087; B66B 5/0025; B66B 11/0226

(57) ABSTRACT

A linkage operating device for an elevator system and an elevator system. The linkage operating device includes an operating portion, configured to be operatively engaged with a base at least in a first position or a second position, the operating portion is in the first position during normal operation of the elevator system, and when the operating portion is operated to disengage from the first position, the detection portion generates a first signal to a stop state; and when the operating portion is operated to be in the second position, the detection portion generates a second signal, and when the detection portion detects that a protective device located at a top of the elevator car is in a working position and defines a car roof protection area, the detection portion generates a third signal to enter a maintenance state.

### FOREIGN PRIORITY

This application claims priority to Chinese Patent Application No. 202411585396.0, filed Nov. 7, 2024, and all the benefits accruing therefrom under 35 U.S.C. § 119, the contents of which in its entirety are herein incorporated by reference.

### TECHNICAL FIELD OF INVENTION

The present disclosure relates to the technical field of elevators, in particular to a linkage operating device for an elevator system and an elevator system.

### BACKGROUND OF THE INVENTION

At present, elevator equipment has been installed and used in many places such as high-rise buildings, stations, airports, private clubs, and family villas, which can greatly facilitate people's daily work, life, and travel. Based on the considerations of safe operation, inspection, and maintenance of elevator equipment, there are usually corresponding requirements for the top floor height and pit depth of the elevator hoistway. In addition, specialized mechanical blocking devices can be installed in the positions near the upper top floor and the lower pit in the elevator hoistway to ensure the minimum safe space between the car roof and the pit, in order to provide safety and error prevention measures for elevator operation, thereby reducing the risks of accidents such as elevator car roof or floor bumps.

The present application has found upon research that the existing mechanical blocking devices of this kind have problems such as difficulty in installation and maintenance operations, large weight, high cost, and lack of safety protection linkage with other devices in the elevator system, especially in application environments with relatively small top floor and/or pit sizes, such as home lifts installed in private residences such as villas.

### SUMMARY OF THE INVENTION

In view of the foregoing, the present disclosure provides a linkage operating device for an elevator system and an elevator system, so as to solve or at least alleviate one or more of the aforementioned problems and other problems in the prior art, or to provide alternative solutions for the prior art.

Firstly, according to one aspect of the present disclosure, a linkage operating device for an elevator system is provided, comprising: a base, arranged on an elevator car; a detection portion, arranged on the elevator car and connected to a controller in the elevator system; and an operating portion, configured to be operatively engaged with the base at least in a first position or a second position, wherein the operating portion is in the first position during normal operation of the elevator system, and when the operating portion is operated to disengage from the first position, the detection portion generates a first signal to be provided to the controller to control the elevator system into a stop state; and when the operating portion is operated to be in the second position, the detection portion generates a second signal, and when the detection portion detects that a protective device located at a top of the elevator car is in a working position and defines a car roof protection area, the detection portion generates a third signal for the controller to control the elevator system into a maintenance state according to the second signal and the third signal, and the operating portion is configured to come into contact with a blocking device located in a preset position in an elevator hoistway to prevent the elevator car from travelling when the elevator car is running in the maintenance state.

In a linkage operating device for an elevator system according to the present disclosure, optionally, the base is arranged at the top of the elevator car and provided with at least a first mating portion and a second mating portion, the operating portion being in the first position when engaged with the first mating portion and in the second position when engaged with the second mating portion.

In a linkage operating device for an elevator system according to the present disclosure, optionally, the base is provided with a first through-hole and a second through-hole closer to an outer side of the elevator car with respect to the first through-hole, and the operating portion comprises: a first rod, having a first end and a second end opposite to each other, and configured to movably pass through the first through-hole and the second through-hole; and a second rod, connected to the first rod and operable to engage with the first mating portion or the second mating portion, wherein when the second rod is engaged with the first mating portion, a second end of the first rod does not exceed the second through-hole, or a portion of the second end of the first rod extending outward beyond the second through-hole does not come into contact with the blocking device when the elevator car is running in the maintenance state; when the second rod is engaged with the second mating portion, the portion of the second end of the first rod extending outward beyond the second through-hole is capable of coming into contact with the blocking device when the elevator car is running in the maintenance state.

In a linkage operating device for an elevator system according to the present disclosure, optionally, the first mating portion and the second mating portion are located between the first through-hole and the second through-hole, the first mating portion and the second mating portion are provided on a side wall of the base and configured as slots, and the second rod is engaged with the base when operatively placed in the slots.

In a linkage operating device for an elevator system according to the present disclosure, optionally, the first rod is configured with a stepped shaft structure, a diameter of the first end is greater than a diameter of the second end, and a diameter of an end portion of the first end is greater than a diameter of the first through-hole.

In a linkage operating device for an elevator system according to the present disclosure, optionally, the stepped shaft structure is configured such that when the operating portion is operated to be in the second position, a surface of the stepped shaft structure triggers the detection portion to generate the second signal.

In a linkage operating device for an elevator system according to the present disclosure, optionally, the second end of the first rod is configured with a first plane and/or a second plane, the first plane is configured to come into contact with a first blocking device located at a first preset distance from the top in the elevator hoistway, and the second plane is configured to come into contact with a second blocking device located at a second preset distance from the bottom in the elevator hoistway.

In a linkage operating device for an elevator system according to the present disclosure, optionally, the detection portion comprises: a first detection member, arranged on the base and/or the operating portion and/or the protective device and/or the elevator car, for generating the first signal; a second detection member, arranged on the base and/or the operating portion and/or the elevator car, for generating the second signal; and a third detection member, arranged on the elevator car and/or the protective device, for generating the third signal.

In a linkage operating device for an elevator system according to the present disclosure, optionally, the first detection member and/or the second detection member and/or the third detection member comprises a contact switch.

In a linkage operating device for an elevator system according to the present disclosure, optionally, the protective device is configured to be in an initial non-working position during normal operation of the elevator system, and when the operating portion is operated to be in the second position and the protective device is operated to enter the working position from the non-working position, the detection portion generates the third signal.

In a linkage operating device for an elevator system according to the present disclosure, optionally, the protective device comprises a guardrail which is placed horizontally at the top of the elevator car in the non-working position and defines the car roof protection area when fixed vertically in position at the top of the elevator car in the working position.

In a linkage operating device for an elevator system according to the present disclosure, optionally, the guardrail is configured as a folding guardrail which is at least partially folded when in the non-working position and at least partially extended in the working position.

In a linkage operating device for an elevator system according to the present disclosure, optionally, the blocking device is provided on an inner side wall of the elevator hoistway or on an elevator guide rail in the elevator hoistway, and/or the blocking device comprises a bracket and a contact member provided on the bracket and having an elastic portion for contacting the operating portion.

Secondly, according to another aspect of the present disclosure, an elevator system is further provided, comprising: an elevator car, configured to travel in an elevator hoistway; a protective device, arranged at a top of the elevator car to define a car roof protection area; a blocking device, arranged in a preset position in the elevator hoistway for blocking the elevator car from traveling forward; and the linkage operating device for an elevator system according to any of the above.

In an elevator system according to the present disclosure, optionally, the elevator system comprises a home lift.

The linkage operating devices according to the present disclosure has the advantages of easy installation and operation, light weight, low cost, and stable and reliable working performance. In particular, it can be operated in association with the elevator car roof protective device in the elevator system and the blocking device in the elevator hoistway, thus providing more comprehensive and reliable safety protection measures for the operation, inspection and maintenance of the elevator system, effectively improving the safety performance of the system. The solutions of the present disclosure have a wide range of applications and are suitable for many environments, such as home lifts and elevators in private places.

### BRIEF DESCRIPTION OF THE DRAWINGS

The technical solutions of the present disclosure will be described in further detail below with reference to the accompanying drawings and embodiments. However, it should be understood that these drawings are designed merely for the purpose of explanation and only intended to conceptually illustrate the structures and configurations described herein, and are not required to be drawn to scale.

FIG. 1 is a three-dimensional structural schematic diagram of an example of an elevator system that can adopt an embodiment of a linkage operating device according to the present disclosure.

FIG. 2 is a three-dimensional structural schematic diagram of an embodiment of a linkage operating device according to the present disclosure installed on an example of an elevator car during normal operation of the example of the elevator system, in which an example of a blocking device located in the elevator hoistway and an example of a protective device located on the car roof and in a non-working position are also shown.

FIG. 3 is a three-dimensional structural schematic diagram of the embodiment of a linkage operating device shown in FIG. 2 when the elevator system is in a maintenance state, in which an example of a blocking device located in the elevator hoistway and an example of a protective device located on the car roof and in the working position are also shown.

FIG. 4 is a local side-view structural schematic diagram of the embodiment of a linkage operating device shown in FIG. 2 when the elevator system is in a maintenance state, in which an example of a protective device located on the car roof and in the working position is also shown.

FIG. 5 is a three-dimensional structural schematic diagram of a portion of the structure in the embodiment of a linkage operating device shown in FIG. 2.

FIG. 6 is a three-dimensional structural schematic diagram of the base in the embodiment of a linkage operating device shown in FIG. 2.

FIG. 7 is an exploded structural schematic diagram of the operating member in the embodiment of a linkage operating device shown in FIG. 2.

FIG. 8 is a three-dimensional structural schematic diagram of the embodiment of a protective device shown in FIG. 2 in the working position, in which a detection member in an embodiment of a linkage operating device that can be installed on the example of the protective device is also shown.

FIG. 9 is a three-dimensional structural schematic diagram of the example of the blocking device shown in FIG. 2 being installed on the example of the elevator hoistway.

### DETAILED DESCRIPTION OF THE INVENTION

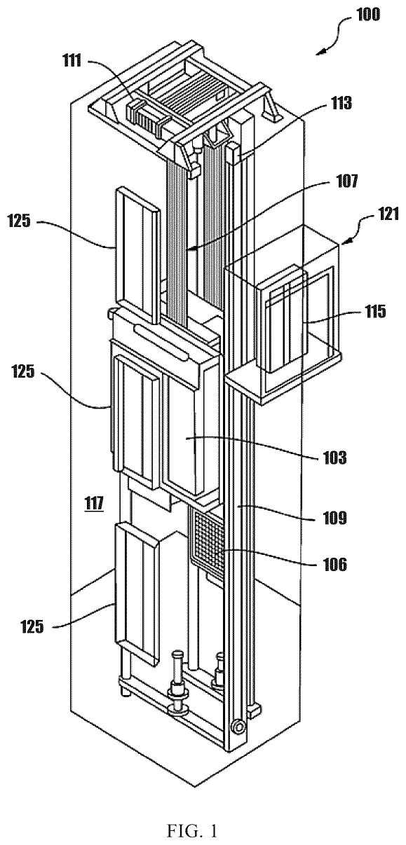

FIG. 1 is a perspective view of an elevator system 100 including an elevator car 103, a counterweight 106, a tension member 107, a guide rail (or rail system) 109, a machine (or machine system) 111, a position reference device 113, and an electronic elevator controller (controller) 115. The elevator car 103 and counterweight 106 are connected to each other by the tension member 107, and travel along an elevator hoistway 117 under the action of driving force. The tension member 107 may include, for example, steel belts (such as coated-steel belts) and/or ropes (such as steel cables). The counterweight 106 is configured to balance a load of the elevator car 103 and is configured to facilitate movement of the elevator car 103 concurrently and in an opposite direction with respect to the counterweight 106 within the elevator hoistway 117 and along the guide rail 109.

The tension member 107 engages the machine 111. The machine 111 is configured to control movement between the elevator car 103 and the counterweight 106. Machine 111 may include a motor or similar power unit to provide driving force to elevator system 100, which may adopt a machine-room-less configuration. The position reference device 113 may be arranged in other positions and/or configurations known in the art, such as being mounted on a fixed part at the top of the elevator hoistway 117, such as on a crossbeam. The position reference device 113 may be configured to provide position signals related to a position of the elevator car and/or counterweight within the elevator hoistway. The position reference device 113 can employ any device or mechanism for monitoring a position of an elevator car and/or counterweight, as known in the art. For example, it includes but is not limited to an encoder, a sensor, or other component, and may include speed sensing, absolute position sensing, and the like.

The controller 115 may be located in a controller room 121 of the elevator hoistway 117 and may be configured to control the operation of the elevator system 100, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference device 113 or any other desired device or system of this kind. When moving up or down within the elevator hoistway 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 100, such as located remotely or in the cloud.

Although specific elevators and components are shown and described herein, FIG. 1 is merely a non-limiting example presented for illustrative and explanatory purposes. It should be noted that other elevator systems can be configured to use the linkage operating devices disclosed herein, such as for environments with relatively small top floor and/or pit space dimensions, such as home lifts, etc. Additionally, for the sake of simplifying the drawing, identical or similar components and features may only be indicated in one or several locations within the same drawing. Technical terms such as “first”, “second”, “third”, etc. are only used for the purpose of distinguishing and are not intended to indicate the order and relative importance thereof. The technical term “connect” (or “engage”) means the realization of connection (or engagement) in a direct or an indirect manner.

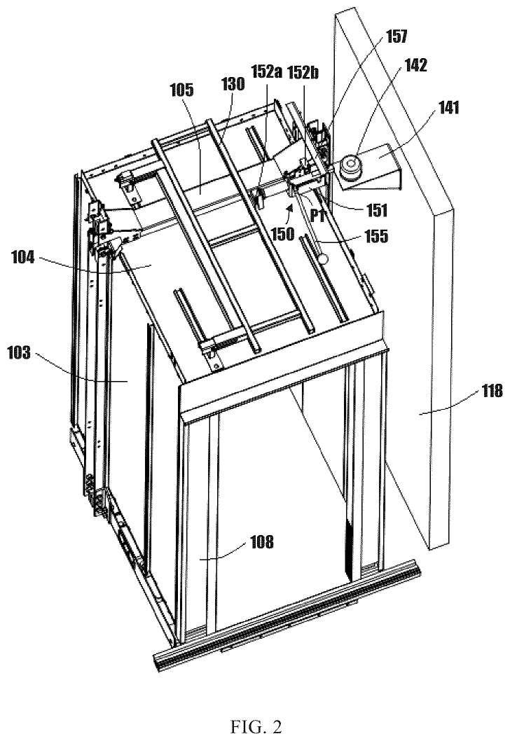

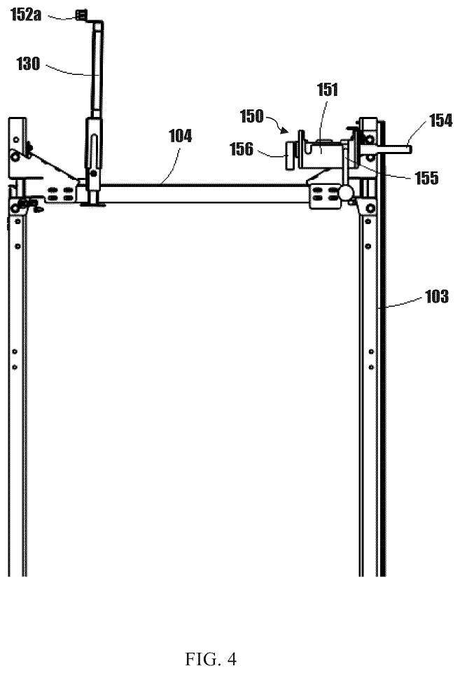

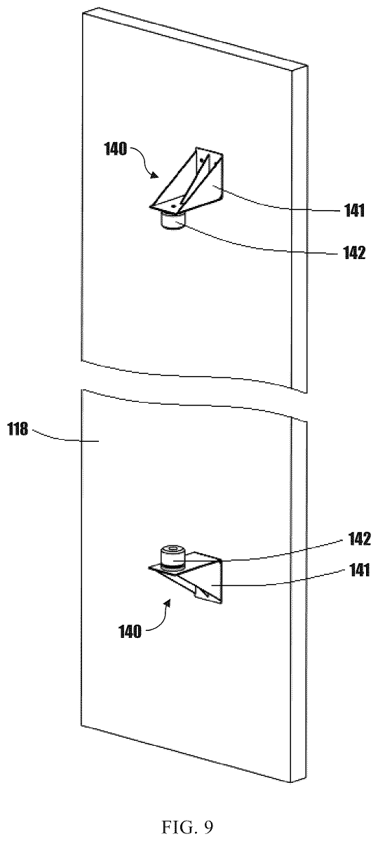

Referring to FIGS. 2 to 9 in conjunction, these figures illustrate, only in an exemplary manner, the general situation of configuring an embodiment of a linkage operating device according to the present disclosure in an example of an elevator system for use. By means of the embodiment of the linkage operating device, workers can easily perform operation control when carrying out elevator equipment inspection, maintenance and the like. In particular, the linkage operating device can be operated in association with the blocking device installed in the elevator hoistway and the protective device located at the top of the elevator car, which can significantly improve the safety performance of the system, ensure the personal safety of workers when working in positions such as the car roof and pit, and minimize safety risks.

Specifically, a linkage operating device 150 may include a base 151, a detection portion 152, and an operating portion 153. The base 151 can be arranged on the elevator car 103, such as being installed on the top 104 of the elevator car 103. For example, the base 151 can be fixed to a structure 105 that can be used for installation and load-bearing located on the car roof, such as a crossbeam, using a bracket 157 and in a detachable form using, for example, bolts, screws, and the like. It should be appreciated that in one or some embodiments, it is allowed to arrange the base 151 in other positions on the elevator car 103, such as being entirely or partially installed on a side of the elevator car 103, and any feasible connection method such as welding can be used alone or in combination to fix the base 151 in place.

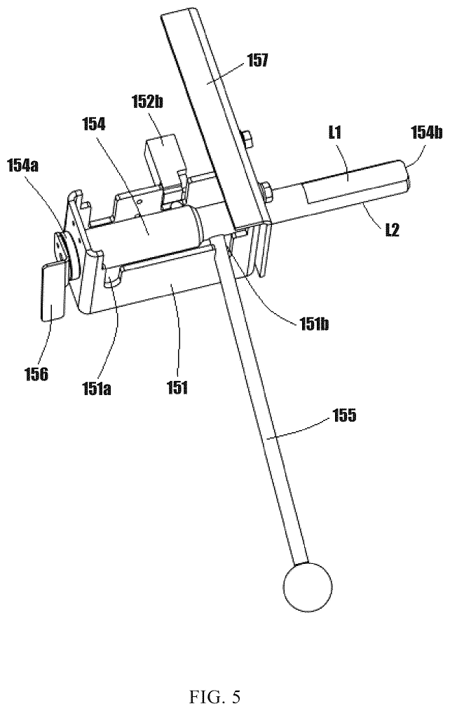

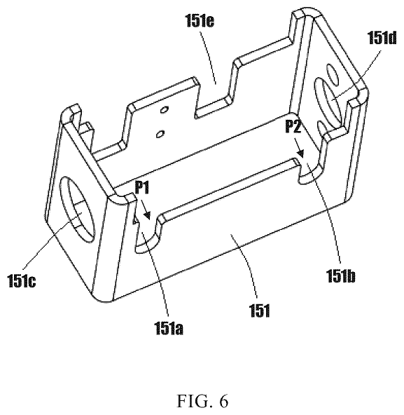

According to the requirements of different application scenarios, the base 151 can be made of one or more suitable materials such as steel, iron, metal alloys, etc., and can be manufactured by one or more suitable processes such as casting, stamping, machining, etc. to meet actual requirements. In addition, the base 151 can be designed with any suitable structure such as hollowed out structure, reinforcing rib, etc. as needed, in order to achieve one or more goals such as saving space, reducing weight, and increasing rigidity. As an example, as shown in FIGS. 5 and 6, mating portions 151a and 151b, through-holes 151c and 151d, and other structures can be provided on the base 151 for use in conjunction with the two rods 154 and 155 used as the operating portion 153 in this embodiment, which will be described in detail below.

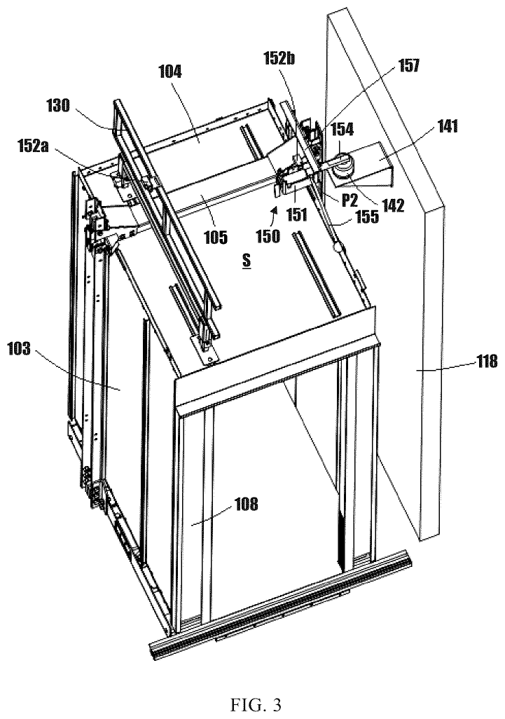

As used herein, the operating portion 153 is configured to be operatively engaged with the base 151 in either the first position P1 or the second position P2. FIGS. 2 and 3 respectively show the specific situations of the operating portion 153 being engaged with the base 151 correspondingly in the first position P1 and the second position P2, with the elevator car door 108 and an inner side wall 118 of the elevator hoistway indicated in the figures. When using the linkage operating device 150, the operating portion 153 can be placed in the first position P1 when the example of the elevator system is in normal operation, i.e., this is the normal position of the linkage operating device 150.

In some cases, for example, when performing inspection, equipment repair, replacement and other operations on the elevator system, the operating portion 153 can be operated to disengage from the first position P1. At this point, the detection portion 152 can be used to detect the above situation and generate a first signal, which will be provided to the controller in the elevator system 100, such as a controller 115 or a controller that can be additionally configured. Then, based on the first signal obtained, the above controller controls the elevator system to enter a stop state. In the stop state, the elevator car 103 is not allowed to travel within the elevator hoistway 117, that is, it cannot run normally or run at an inspection speed.

When the operating portion 153 is operated to disengage from the first position P1 and then continues to operate to enter the second position P2, the detection portion 152 can detect the above situation that has occurred and generate a second signal accordingly. Subsequently, the detection portion 152 can be used to detect whether the protective device 130 (such as guardrail, etc.) usually arranged at the top 104 of the elevator car 103 is currently in the working position. That is, when the protective device 130 is in the working position, it will define the car roof protection area, thereby providing effective safety protection for workers such as those entering the car roof for work. In FIG. 3, the above car roof protection area has been indicated with the reference sign S. When the protective device 130 is currently in the working position and provides the car roof protection area S, for example, when the protective device 130 is configured to remain in the working position, the detection portion 152 can be used for detection and generates a third signal accordingly.

According to the second and third signals mentioned above, the above controller in the elevator system 100 can control the elevator system to officially enter the maintenance state. That is, in order to improve the safety and reliability of the system, especially considering the effectiveness of the states of the respective devices in association, only when the protective device 130 and the linkage operating device 150 used in conjunction with the blocking device 140 are both in the correct positions, can the elevator system enter the maintenance state. This can minimize the safety risk of the system and ensure the safety of personnel and equipment.

In the maintenance state, operations related to equipment inspection, maintenance, replacement, etc. can be carried out on the elevator system. For example, the elevator car 103 can be controlled to travel at a relatively low inspection speed within the elevator hoistway 117, thereby effectively ensuring the personal safety of the maintenance personnel and avoiding possible damage to the equipment. In addition, since the operating portion 153 is currently in the second position P2 during maintenance, once the elevator car 103 travels to the blocking device 140 installed in the elevator hoistway 117, the operating portion 153 will come into contact with the blocking device 140, thereby preventing the elevator car 103 from continuing to travel even in the event of an unexpected upward or downward movement of the elevator car during elevator maintenance, the elevator car can be forced to stop running in a timely and reliable manner, ensuring the safety of personnel and equipment. The configuration and usage of the blocking device 140 will be described later.

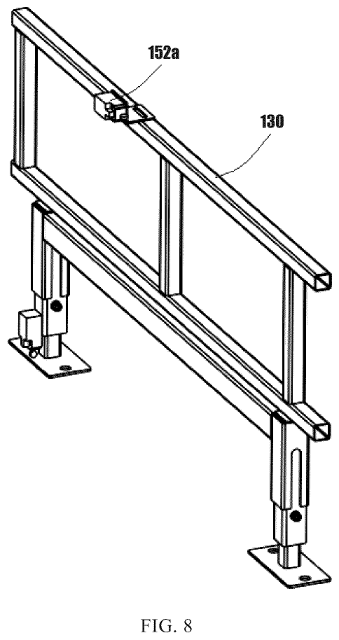

For the protective device 130, it can generally be in the form of, for example, a guardrail, optionally in the form of a folding guardrail. In the normal state, that is, when the elevator system is operating normally, in one or some embodiments, the protective device 130 can be placed in the initial non-working position, i.e., it can be horizontally placed on the top 104 of the elevator car 103, and the operating portion 153 in the linkage operating device 150 is at this point engaged with the base 151 in the first position P1. After adjusting the operating portion 153 to engage with the base 151 in the second position P2 according to application requirements, the protective device 130 can be operated to be adjusted from the previous non-working position to the working position, so that the protective device 130 can be vertically fixed in place at the top 104 of the elevator car 103 in the working position to construct a car roof protection area S. This can provide effective safety protection for maintenance personnel and other personnel when they are working on the car roof, thereby avoiding accidents such as accidentally falling into the elevator hoistway or touching mechanical and electrical equipment that should be kept away from. FIG. 8 only schematically shows a folding guardrail structure, which can be folded up at least partially and placed flat on the car roof when it is in the non-working position. When in the working position, it can be fully or partially unfolded. The unfolded guardrail can form a basically or mostly closed frame structure, except for, for example, entrances and exits for personnel, so as to provide safer and more reliable protection functions.

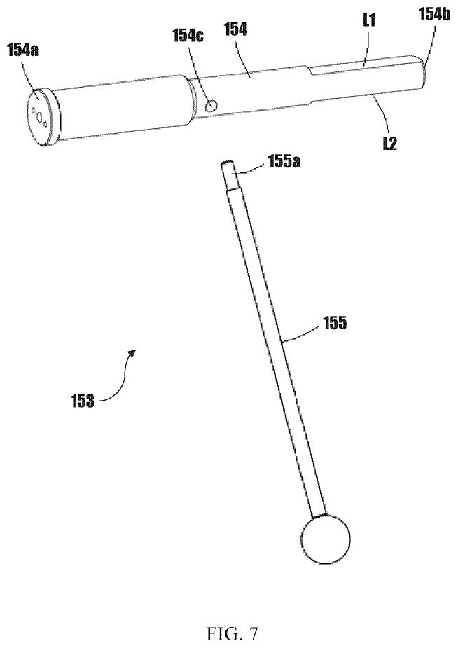

As used herein, in various embodiments, the operating portion 153 can be configured with a first rod 154 and a second rod 155, which can be made of the same or different materials, and can be integrally formed or detachably connected together. For example, as exemplarily shown in FIG. 7, a threaded hole 154c can be provided on the first rod 154, and then the corresponding end 155a of the second rod 155 can be screwed into the threaded hole 154c, thereby connecting the first rod 154 and the second rod 155 together.

As shown in FIGS. 5, 6, and 7, when assembling the linkage operating device 150, the first rod 154 can movably pass through the through-holes 151c and 151d on the base 151. The through-hole 151d is closer to the outer side of the elevator car 103 compared to the through-hole 151c, that is, the first end 154a of the first rod 154 corresponds to the side of the through-hole 151c, and the second end 154b corresponds to the side of the through-hole 151d and can be moved to extend beyond the through-hole 151d when required, so as to make contact with the blocking device 140 in the maintenance state. The specific length of the second end 154b extending beyond the through-hole 151d can be configured according to actual requirements. For example, in one or some implementation scenarios, the second end 154b can be designed to not extend beyond or slightly exceed the through-hole 151d during normal operation of the elevator system. The portion slightly exceeding the through-hole 151d will not interfere with the normal operation of the elevator system, i.e., it will not come into contact with the blocking device 140.

The second rod 155 is connected to the first rod 154. For example, workers can operate the second rod 155 outside the elevator hoistway when required to change the position of the operating portion 153, such as disengaging from the first position P1 and entering the second position P2, and vice versa. During operation, the second rod 155 can be fitted and engaged with the corresponding mating portion 151a or 151b provided on the base 151, thereby achieving operable engagement between the operating portion 153 and the base 151. As an example, as used herein, the mating portions 151a and 151b can be optionally configured in the form of slots, which can be provided on the side wall of the base 151 and located between the two through-holes 151c and 151d. When operating the second rod 155, it can be selected to be placed in the corresponding slot, so that the operating portion 153 can be engaged with the base 151 in the first position P1 or the second position P2.

In one or some embodiments, the first rod 154 can be configured with a stepped shaft structure. For example, the diameter of its first end 154a can be made greater than the diameter of its second end 154b, which is beneficial for forming a more stable structure and enabling the operating portion 153 to withstand impact more effectively when it may come into contact with the blocking device 140. In addition, the first rod 154 can be configured such that the diameter of the end portion of the first end 154a is greater than the diameter of the through-hole 151c of the base 151. This is beneficial for limiting the range of movement distance of the first rod 154 and the second rod 155 relative to the base 151 during use. That is, when the first rod 154 is operated to move such that the second end 154b extends outward from the through-hole 151d beyond a preset distance, as the through-hole 151c can block the end of the first end 154a at this point, the first rod 154 cannot continue to move and further extend outward, thus avoiding possible improper operations that may cause the second end 154b to extend outward excessively. The excessively extended portion as mentioned above may cause unnecessary damage to elevator guide rails, blocking devices, etc. in the elevator hoistway and the linkage operating device 150 itself when the elevator car is running at the inspection speed.

With continued reference to FIGS. 3, 5, and 7, as used herein, in a plurality of embodiments, a first plane L1 and/or a second plane L2 can be optionally provided on the second end 154b of the first rod 154, in order to facilitate contact with the blocking device 140 arranged at a preset distance from the top in the elevator hoistway 117 by means of the first plane L1, and to facilitate contact with the blocking device 140 arranged at a preset distance from the bottom in the elevator hoistway 117 by means of the second plane L2, because this will effectively increase the area of force application, thus allowing the impact force and vibration generated and withstood to be more uniform and balanced when contact occurs.

It should be noted that the blocking device 140 can be installed in any suitable position, such as the inner side wall 118 of the elevator hoistway 117 or the elevator guide rail 109, according to actual application requirements. Usually, a blocking device 140 can be installed respectively at a certain distance from the top and bottom of the elevator hoistway 117 to limit the upward-going and downward-going distance of the elevator car 103 during maintenance, thereby ensuring that both the car roof and pit have a safe space that meets actual requirements. However, it should be appreciated that the specific installation positions of the blocking devices 140 at the top and bottom can be configured and adjusted according to actual application requirements, and their corresponding distances from the top or bottom can be the same or different. Moreover, they themselves can also be the same or different from each other in terms of structural configuration, size, and materials used.

For the blocking device 140, as used herein, it can be optionally configured to include a bracket 141 and a contact member 142. The latter can be installed on the bracket 141 to cooperate with the operating portion 153 of the linkage operating device 150 to limit a safe space for the car roof and/or pit that meets specific application requirements. For example, in the above example discussed, the contact member 142 can come into contact with the portion of the second end 154b of the first rod 154 extending out of the through-hole 151d when the first rod 154 is in the second position P2, where the portion can be configured with a plane L1 or a plane L2 facing the contact member 142 as mentioned above. As an optional configuration, the contact member 142 can be provided with an elastic portion. For example, the contact member 142 can be completely or partially made of elastic materials such as rubber, so as to be more conducive to absorbing energy, reducing vibration, impact, and noise when in contact with the operating portion 153, so that the structures such as beams and columns on the elevator car are barely affected.

By the coordinated use of the blocking device 140 and the linkage operating device 150, system safety can be guaranteed. In addition, due to the light weight, easy installation and operation, and the overall low cost, it is particularly suitable for applications for scenarios where the space size of the top floor and/or pit is relatively small, such as in environments with home lifts such as villas and private clubs.

It is described previously that in the linkage operating device 150, the detection portion 152 can generate corresponding signals based on the current working or position states of the linkage operating device 150 and the protective device 130, and provide them to the controller in the elevator system 100. Based on this, the elevator system can then be controlled to enter the corresponding state, and the linkage operations of the linkage operating device 150 with the protective device 130, the blocking device 140, etc. can be achieved. This can fully ensure personal safety on site, prevent equipment damage, and improve the safety performance of the elevator system.

According to the present disclosure, those skilled in the art can appreciate and allow the application of any feasible means to implement the detection portion 152. As used herein, in a plurality of embodiments, the detection portion 152 can be configured with a first detection member 152a, a second detection member 152b, and a third detection member (not shown) to generate the aforementioned first signal, second signal, and third signal accordingly. As an optional scenario, each of the above detection members can use one or more suitable components, such as contact switches, non-contact signal triggers (e.g., in the form of infrared radiation), etc., where the solutions of the present disclosure do not make any restrictions in this regard.

For example, the first detection member 152a can be, for example, selectively arranged on one or more of the base 151, the operating portion 153, the protective device 130, and the elevator car 103. For example, it can be installed on the protective device 130, which is placed in the non-working position as discussed earlier in the normal state. The first detection member 152a can operate in cooperation with the mating portion 156 installed on the base 151, so that when the operating portion 153 is operated to disengage from the first position P1, the first detection member 152a generates a first signal accordingly in response to the displacement change between the mating portion 156 and the first detection member 152a located on the protective device 130 that occurs at this point. For another example, the second detection member 152b can be selectively arranged on one or more of the base 151, the operating portion 153, and the elevator car 103, so that when the operating portion 153 enters the second position P2 and engages with the base 151, a second signal can be generated by the second detection member 152b accordingly. As shown in FIGS. 5 and 6, the second detection member 152b can be optionally arranged near the opening 151e on the side wall of the base 151. For example, when the first rod 154 of the operating portion 153 is configured with a stepped shaft structure, when the first rod 154 is operated to enter the second position P2, the surface of the stepped shaft structure can be used to come into contact with the second detection member 152b, thus triggering the second detection member 152b to generate a corresponding second signal at this point. For yet another example, the third detection member can be selectively arranged in any suitable position on the elevator car 103. When the protective device 130 is always in the working position or is operated to be in the working position, the third detection member can detect it and generate a corresponding third signal.

It should be pointed out that although it has been described previously that the linkage operating device 150 and the protective device 130 can be manually operated by the workers, such as manually operating the second rod 155 outside the elevator hoistway to change the engagement position, manually operating the protective device 130 from the optional non-working position to the working position after the workers entering the car roof, and the like. In some application scenarios, however, power can be provided by, for example, motors, or devices such as reset springs can be configured to complete such operations. For example, a reset spring can be configured for the protective device 130 to be operated, so that when the operating portion 153 disengages from the first position P1, the spring force can be used to drive the protective device 130 from the non-working position to the working position, thereby eliminating the need for manual operation by the workers and further enhancing operation convenience. In addition, the communication connection between the detection portion 152 in the linkage operating device 150 and the controller in the elevator system 100 can be wired, wireless, or a combination thereof, so as to better meet various application requirements.

A linkage operating device for an elevator system and an elevator system according to the present disclosure have been described above in detail by way of examples only. These examples are merely used to illustrate the principles and embodiments of the present disclosure, rather than limiting the present disclosure. Various modifications and improvements can be made by those skilled in the art without departing from the scope of the present disclosure. Therefore, all equivalent technical solutions should fall within the scope of the present disclosure and be defined by the claims of the present disclosure.

What is claimed is:

1. A linkage operating device for an elevator system, comprising:
a base, arranged on an elevator car;
a detection portion, arranged on the elevator car and connected to a controller in the elevator system; and
an operating portion, configured to be operatively engaged with the base at least in a first position or a second position, wherein the operating portion is in the first position during normal operation of the elevator system, and when the operating portion is operated to disengage from the first position, the detection portion generates a first signal to be provided to the controller to control the elevator system into a stop state; and
when the operating portion is operated to be in the second position, the detection portion generates a second signal, and when the detection portion detects that a protective device located at a top of the elevator car is in a working position and defines a car roof protection area, the detection portion generates a third signal for the controller to control the elevator system into a maintenance state according to the second signal and the third signal, and the operating portion is configured to come into contact with a blocking device located in a preset position in an elevator hoistway to prevent the elevator car from travelling when the elevator car is running in the maintenance state.

2. The linkage operating device for an elevator system according to claim 1, wherein the base is arranged at the top of the elevator car and provided with at least a first mating portion and a second mating portion, the operating portion being in the first position when engaged with the first mating portion and in the second position when engaged with the second mating portion.

3. The linkage operating device for an elevator system according to claim 2, wherein the base is provided with a first through-hole and a second through-hole closer to an outer side of the elevator car with respect to the first through-hole, and the operating portion comprises:
a first rod, having a first end and a second end opposite to each other, and configured to movably pass through the first through-hole and the second through-hole; and
a second rod, connected to the first rod and operable to engage with the first mating portion or the second mating portion, wherein when the second rod is engaged with the first mating portion, a second end of the first rod does not exceed the second through-hole, or a portion of the second end of the first rod extending outward beyond the second through-hole does not come into contact with the blocking device when the elevator car is running in the maintenance state; when the second rod is engaged with the second mating portion, the portion of the second end of the first rod extending outward beyond the second through-hole is capable of coming into contact with the blocking device when the elevator car is running in the maintenance state.

4. The linkage operating device for an elevator system according to claim 3, wherein the first mating portion and the second mating portion are located between the first through-hole and the second through-hole, the first mating portion and the second mating portion are provided on a side wall of the base and configured as slots, and the second rod is engaged with the base when operatively placed in the slots.

5. The linkage operating device for an elevator system according to claim 3, wherein the first rod is configured with a stepped shaft structure, a diameter of the first end is greater than a diameter of the second end, and a diameter of an end portion of the first end is greater than a diameter of the first through-hole.

6. The linkage operating device for an elevator system according to claim 5, wherein the stepped shaft structure is configured such that when the operating portion is operated to be in the second position, a surface of the stepped shaft structure triggers the detection portion to generate the second signal.

7. The linkage operating device for an elevator system according to claim 3, wherein the second end of the first rod is configured with a first plane and/or a second plane, the first plane is configured to come into contact with a first blocking device located at a first preset distance from the top in the elevator hoistway, and the second plane is configured to come into contact with a second blocking device located at a second preset distance from the bottom in the elevator hoistway.

8. The linkage operating device for an elevator system according to claim 1, wherein the detection portion comprises:
a first detection member, arranged on the base and/or the operating portion and/or the protective device and/or the elevator car, for generating the first signal;
a second detection member, arranged on the base and/or the operating portion and/or the elevator car, for generating the second signal; and
a third detection member, arranged on the elevator car and/or the protective device, for generating the third signal.

9. The linkage operating device for an elevator system according to claim 8, wherein the first detection member and/or the second detection member and/or the third detection member comprises a contact switch.

10. The linkage operating device for an elevator system according to claim 1, wherein the protective device is configured to be in an initial non-working position during normal operation of the elevator system, and when the operating portion is operated to be in the second position and the protective device is operated to enter the working position from the non-working position, the detection portion generates the third signal.

11. The linkage operating device for an elevator system according to claim 10, wherein the protective device comprises a guardrail which is placed horizontally at the top of the elevator car in the non-working position and defines the car roof protection area when fixed vertically in position at the top of the elevator car in the working position.

12. The linkage operating device for an elevator system according to claim 11, wherein the guardrail is configured as a folding guardrail which is at least partially folded when in the non-working position and at least partially extended in the working position.

13. The linkage operating device for an elevator system according to claim 1, wherein the blocking device is provided on an inner side wall of the elevator hoistway or on an elevator guide rail in the elevator hoistway, and/or the blocking device comprises a bracket and a contact member provided on the bracket and having an elastic portion for contacting the operating portion.

14. An elevator system, comprising:
an elevator car, configured to travel in an elevator hoistway;
a protective device, arranged at a top of the elevator car to define a car roof protection area;
a blocking device, arranged in a preset position in the elevator hoistway for blocking the elevator car from traveling; and
the linkage operating device for an elevator system according claim 1.

15. The elevator system according to claim 14, wherein the elevator system comprises a home lift.
